(19) United States
(12) Patent Application Publication
(10) Pub. No.: US 2003/0026682 A1
(43) Pub. Date: Feb. 6, 2003

(54) Synchronized palletizer

(76) Inventors: Stephen L. Heston, West Linn, OR (US); Cary Michael Pierson, Milwaukie, OR (US)

Correspondence Address: KEITH A. CUSHING, Registered Patent Attorney, 4201 S.W. VACUNA STREET, PORTLAND, OR, 97219, US

(21) Appl. No.: 09/920,317

(22) Filed: Aug. 1, 2001

(51) Int. Cl. B65G 57/06

(52) U.S. Cl. 414/791.6; 414/792.6; 414/793.5; 414/794.1

(57) ABSTRACT

A synchronized palletizer includes a row conveyor and a layer head, each vertically reciprocating within a frame. An infeed conveyor delivers in series items row-by-row onto the row conveyor. The row conveyor moves to vertically coincide with the layer head and laterally transfer a row items onto the layer head. Once a complete item layer has been constructed on the layer head, the layer head collapses the layer together and drops the layer through its floor onto a pallet or stack of item layers therebelow. Generally, the layer head vertical position follows the top of stack of item layers and the row conveyor travels reciprocally between the infeed conveyor and the layer head to deliver items row-by-row to the layer head. A variety of alternative relative positioning schemes, however, may be implemented.

### BACKGROUND OF THE INVENTION

The present invention relates generally to article manipulation devices and particularly to a palletizing device and method of operation.

Palletizers receive a sequence of items and produce a palletized stack of items. Generally, items are formed into rows, rows formed into layers, and layers stacked upon a pallet to form a palletized stack of items. Thus, a typical palletizer receives a series of items and organizes the items by row, by layer, and ultimately as a palletized stack of items on a pallet.

Palletizing calls for efficiency. In many applications, time is most critical. A palletizer more efficiently, i.e., more quickly, organizing an incoming series of items into a palletized stack of items represents advantage in greater production levels, i.e., greater item throughput.

Another important palletizing consideration is size. A more compact machine takes less floor space and, if necessary, accommodates more palletizing machines in the same area as would be occupied by relatively larger palletizing machines. Compact size is, therefore, a desirable feature in a palletizer.

Accordingly, it would be desirable to provide a palletizer having both improved time efficiency and reduced overall size relative to conventional palletizing devices. The subject matter of the present invention provides such a palletizer.

### SUMMARY OF THE INVENTION

A synchronized palletizer under the present invention receives serially items for palletizing on a vertically reciprocating row conveyor. A vertically reciprocating layer head receives items laterally row-by-row from the row conveyor and serves as a layer construction site. The layer head drops completed item layers therethrough onto a pallet therebelow or onto a stack of item layers resting on a pallet therebelow.

The subject matter of the present invention is particularly pointed out and distinctly claimed in the concluding portion of this specification. However, both the organization and method of operation of the invention, together with further advantages and objects thereof, may best be understood by reference to the following description taken with the accompanying drawings wherein like reference characters refer to like elements.

### BRIEF DESCRIPTION OF THE DRAWINGS

For a better understanding of the invention, and to show how the same may be carried into effect, reference will now be made, by way of example, to the accompanying drawings in which:

FIG. 1 illustrates in perspective a synchronized palletizer according to a preferred embodiment of the present invention.

FIG. 2 illustrates in plan view the synchronized palletizer of FIG. 1 as taken along lines 2-2 of FIG. 1.

FIG. 3 illustrates in side view a layer head of the palletizer of FIG. 1.

FIG. 4 illustrates in perspective the layer head of FIG. 3.

FIG. 5 illustrates in perspective a dead plate of the layer head of FIGS. 3 and 4.

### DETAILED DESCRIPTION OF THE PREFERRED EMBODIMENT

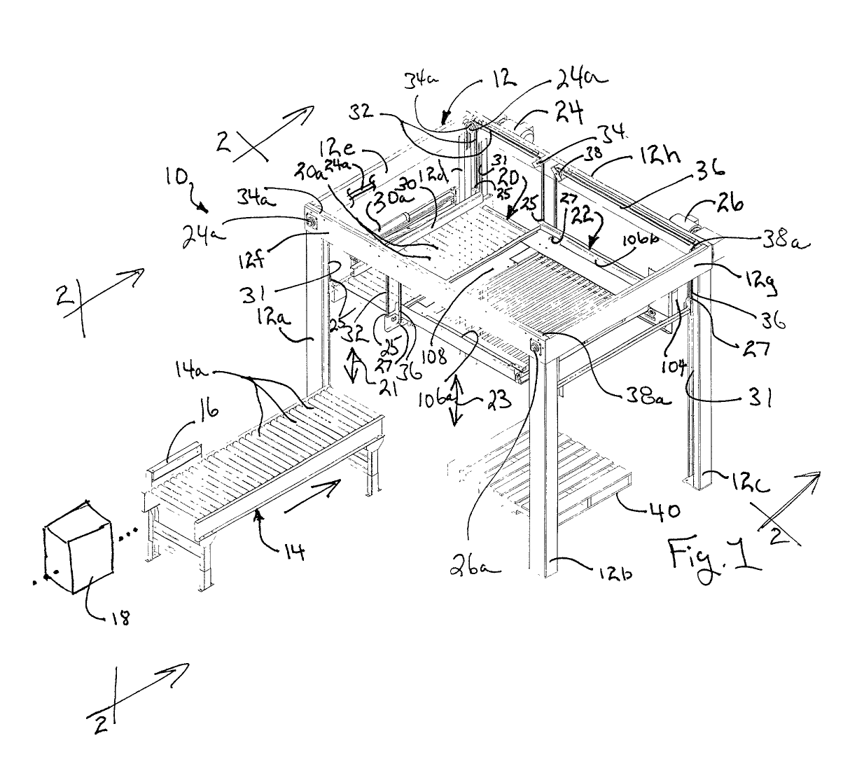

FIG. 1 illustrates in perspective and FIG. 2 in side view a palletizer 10 according to a preferred embodiment of the present invention. In FIGS. 1 and 2, palletizer 10 includes a frame 12 of generally box-form configuration. Frame 12 includes four vertical posts, individually posts 12a-12d, supporting an upper structure comprising horizontal beams 12e-12h. Thus, the lower end of each of posts 12a-12d rests on a floor and the upper ends of posts 12a-12d support beams 12e-12h. Beams 12e-12h provide a generally horizontal rectangular structure maintained at a given level above floor level. Generally, frame 12 provides a relatively compact overall structure supporting therein elements of palletizer 10 as described more fully hereafter.

Adjacent frame 12, palletizer 10 includes an infeed conveyor 14. Infeed conveyor 14 is a “production level” conveyor receiving, for example, output from a production or manufacturing operation or from a repackaging operation. Infeed conveyor 14 includes along its length a series of live, i.e., powered, rollers 14a. Infeed conveyor 14 also includes a case turner 16. Case turner 16 manipulates incoming items 18, e.g., cases of products, appropriately according to programmed layer building patterns. Use of case turner 16 and layer building methods and patterns are well known in the art.

Generally, infeed conveyor 14 moves a series of items 18 therealong for presentation to the remaining portions of palletizer 10 as operating within frame 12. As may be appreciated, infeed conveyor 14 and turner 16 operate cooperatively to appropriately orient a sequence of items 18 according to a programmed layer building pattern including contemplation of necessary sequential row patterns interfitting to form layer patterns and layer patterns interrelating to produce a stable stack of items on a pallet 40. Thus, it will be understood that items 18 are not necessarily symmetrical and may be oriented according to a specific predefined layer building pattern taking into account row-by-row variations within a layer and layer-to-layer variations for adjacent layers on a stack of item 18 layers resting on pallet 40.

Within frame 12, palletizer 10 includes a vertically reciprocating row conveyor 20 and a vertically reciprocating layer head 22. A row conveyor lift motor 24 when actuated vertically reciprocates conveyor 20 as indicated at reference numeral 21. A layer head motor 26 when actuated vertically reciprocates layer head 22 as indicated at reference numeral 23. Generally, each of row conveyor 20 and layer head 22 are independently suspended within frame 12. More particularly, row conveyor 20 hangs from four suspension points 25. Layer head 22 hangs from four suspension points 27. Each of conveyor 20 and layer head 22 carry a pair of guides 29. Each of vertical posts 12a-12d carry on their inner surface a corresponding guide track 31. Thus, guide tracks 31 on posts 12a and 12d interfit guides 25 of row conveyor 20 and maintain conveyor 20 along a vertical path within frame 12. Similarly, guide tracks 31 on vertical posts 12b and 12c interfit with guides 27 on layer head 22 to maintain layer head 22 along a vertical path within frame 12.

Suspension chains and associated sprockets couple each of row conveyor 20 and layer head 20 to the respective motors 24 and 26. More particularly, row conveyor 20 hangs within frame 20 from a first set of four suspension chains 32 routed through appropriate sprockets 34 and coupled to motor 24. Actuation of motor 24 in a first direction lowers row conveyor 20 and actuation in the opposite direction raises row conveyor 20. Specifically, the output shaft 24a of drive motor 24 extends the length of horizontal beam 12e (shown only partially in FIG. 1) and carries at each end a pair of sprockets 34a. Suspension chains 36 engage sprockets 34a and move in response to rotation of sprockets 34a. One end of each of chains 32 couples to a suspension point 25 and the other end of each of suspension chains 32 carries a counter weight (not shown) depending directly below each pair of sprockets 34a. In this manner, chains 32 remain engaged relative to sprockets 34a and, therefore, relative to drive motor 24.

Similarly, a second set of four suspension chains 36 and sprockets 38 suspend layer head 22 within frame 12 and couple to motor 26. Actuation of motor 26 in a first direction moves layer head 22 upward and actuation in the opposite direction lowers layer head 22. Specifically, the output shaft 26a of drive motor 26 extends the length of horizontal beam 12g (shown only partially in FIG. 1) and carries at each end a pair of sprockets 38a. Suspension chains 36 engage sprockets 38a and move in response to rotation of sprockets 38a. One end of each of chains 36 couples to a suspension point 27 and the other end of each of suspension chains 36 carries a counter weight (not shown) depending directly below each pair of sprockets 38a. In this manner, chains 36 remain engaged relative to sprockets 38a and, therefore, relative to drive motor 26.

Thus, row conveyor 20 and layer head 22 operate independently and may be vertically positioned by appropriately actuating and controlling motors 24 and 26, respectively.

Row conveyor 20 moves to a lower position vertically coincident with the height of infeed conveyor 14 to receive from infeed conveyor 14 one row of items 18. As discussed above, the row of items 18 presented to row conveyor 20 at the output of conveyor 14 correspond to an ongoing layer building pattern, i.e., particular ones of the items 18 within a given row are suitably oriented according to and overall sequence of item 18 orientation pattern. As live rollers 14a propel a sequence of items 18 onto row conveyor 20, live rollers 20a activate and collect the sequence of items 18 as a row onto conveyor 20. As may be appreciated, live rollers 20a are suitably operated in coordination with live rollers 14a of conveyor 14 to pass serially a given set of items 18 from conveyor 14 onto conveyor 20. In this manner, conveyor 20 receives one row of items 18 from conveyor 14. Conveyor 20 is then vertically positioned as necessary to vertically coincide with a current height of layer head 22 to pass the row of items 18 from conveyor 20 to layer head 22.

As may be appreciated, because both row conveyor 20 and layer head 22 independently vertically reciprocate a broad combination of relative movements may be accomplished by programmed control to transfer a row of items 18 from conveyor 20 to layer head 22, i.e., one of the two devices may be moved to match the height of the other or both moved to match some intermediate or predetermined height according to programmed control. Generally, however, it is contemplated that the relatively higher speed conveyer 20 “chase’ layer head 22, i.e., seek out a current height for layer head 22, when transferring a row of items 18 from conveyor 20 onto layer head 22. In this particular embodiment, conveyor 20 includes a row pusher 30 of generally conventional design including a pneumatic cylinder 30a for pushing a row of items 18 from conveyor 20 onto layer head 22. Thus, row conveyor 20 vertically aligns itself with a current vertical position of layer head 22 and passes laterally a row of items 18 from conveyor 20 to layer head 22.

Generally, layer head 22 tracks the height of a stack of items 18 layer as positioned on a pallet 40. Pallet 40 rests at floor level and receives layer-by-layer items 18 from layer head 22. Once a complete layer of items 18 has been built row-by-row on layer head 22, layer head 22 deposits the entire layer as a next layer on pallet 40 or on a stack of layers resting on pallet 40. As will be described more fully hereafter, layer head 22 withdraws its support from below a layer of items 18 and drops the layer onto a pallet 40 below or onto a stack of item 18 layers resting on pallet 40 below. Layer head 22 then repositions itself, i.e., raises, to prepare to receive a next item 18 layer row-by-row from row conveyor 20.

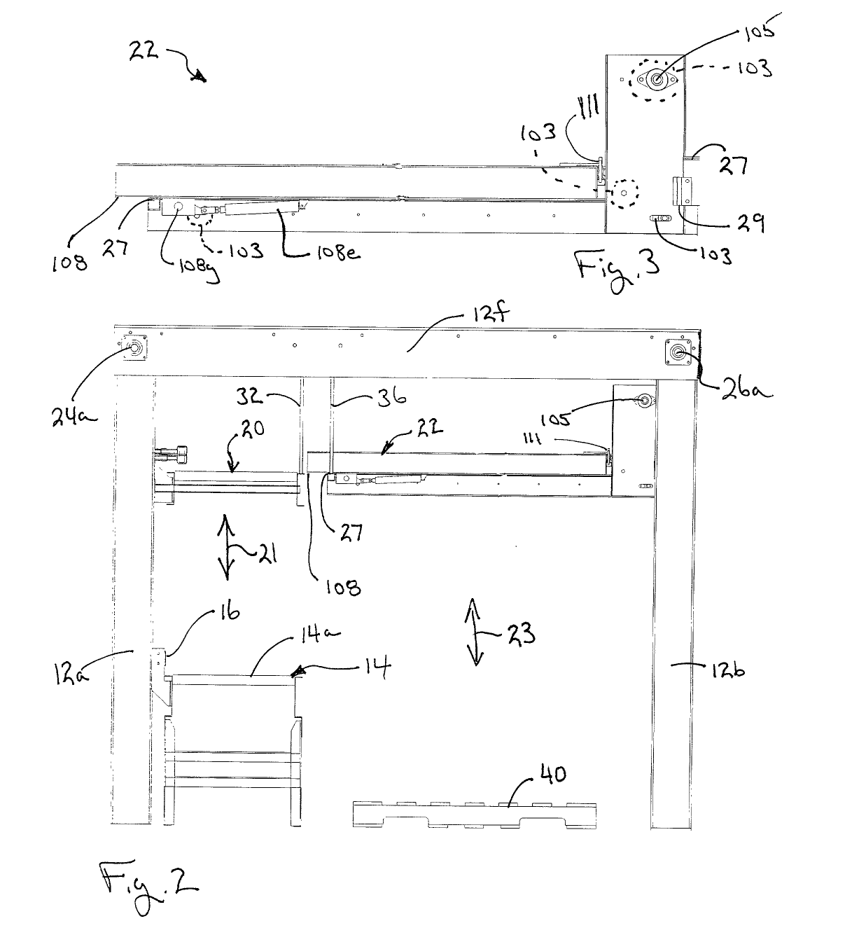

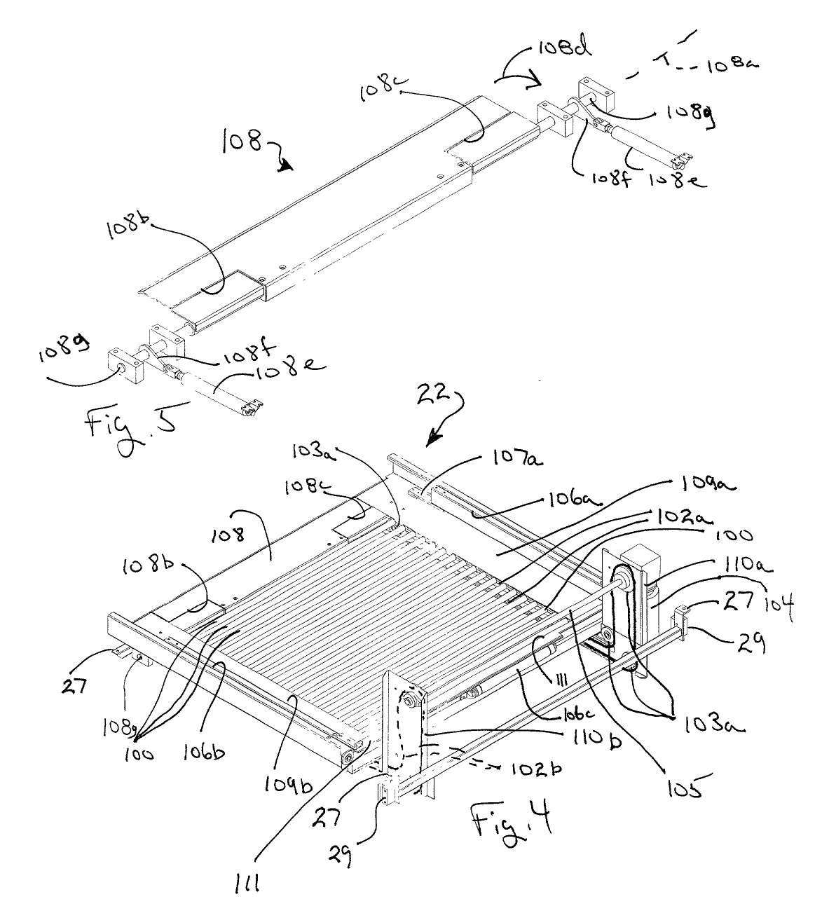

FIGS. 3 and 4 detail layer head 22 as detached from frame 12. FIG. 5 illustrates a dead plate 108 of layer head 22, but detached therefrom for purposes of illustration. In FIGS. 3-5, layer head 22 includes a set of free rollers 100 carried on a pair of chains 102a and 102b. Sprockets 103a constrain chain 102a to an L-shaped path. Similarly, sprockets 103b restrict chain 102b to a corresponding L-shaped path. Rollers 100 attach to a length segment of chain 102a and thereby create a removable floor relative to layer head 22. A drive shaft 105 couples to one of sprockets 103a and one of sprockets 103b and thereby ties together chains 102a and 102b. Drive motor 104 turns shaft 105 to move chains 102a and 102b along their respective and coordinated L-shaped paths. A pair of vertical plates 110, individually 10a and 110b, support shaft 105 and also carry thereacross a stop 111, i.e., a raised edge formation. Stop 111 engages a leading lower edge of an item 18 layer while being dropped from layer head 22.

Floor drive motor 104 operates to move chains 102 and thereby withdraw rollers 100 from a supporting or floor position relative to an item 18 layer to an open position allowing an item 18 layer to drop through layer head 22 onto a pallet 40 therebelow or onto a stack of item 18 layers therebelow. Advancing rollers 100 rightward, in the view of FIGS. 3 and 4, moves rollers 100 out of a floor position as illustrated in FIG. 4 and into an open position occupying the vertical portion of the L-shaped path provided by sprockets 103 and chains 102. Once the leading edge of the item 18 layer engages stop 111, the item 18 layer holds its position and rollers 100 continue to move out from thereunder to drop the item 18 layer therebelow. The first row of items 18 to fall from layer head 22 is the row most distant from stop 111. Thus, the first-to-arrive row of items 18, i.e., the row first placed on layer head 22 when constructing a layer, is the last row to fall from layer head 22 when releasing an item 18 layer. The last-to-arrive row is, therefore, the first row dropped from layer head 22. In this manner, a complete item 18 layer drops through the opened floor of layer head 22.

Layer head 22 includes conditioning mechanisms to better organize a given item 18 layer thereon prior to dropping the layer on a pallet 40 or a stack of layers therebelow. As discussed above, palletizer 10 accommodates an ongoing layer building pattern. Items 18 of varying orientation must be organized into a layer. A relatively loose, i.e., with space therebetween, initial organization of items 18 better facilitates layer building patterns. Thus, as initially organized on layer head 22, items 18 are loosely packed but possess the required relative orientations to form, when brought together, a desired and compact overall item 18 configuration within a given layer. Generally, layer head 22 includes conditioning mechanisms to collapse together along orthogonal dimensions a loosely packed item 18 layer into a tightly packed item 18 layer.

A pair of side clamps 106, individually 106a and 106b, move laterally inward in a first dimension and compress together an item 18 layer in preparation for deposit on a stack of item 18 layers therebelow. A pneumatic cylinder 106c couples by way of scissor mechanism 107 (shown partially at reference numeral 107a in FIG. 4) to operate clamps 106a and 106b in parallel, i.e., move laterally inward in parallel and coordinated orientation. A dead plate 108 (shown separately in FIG. 5) rotates about an axis 108a, i.e. flips up into and past a vertical position, to compress a layer of items in a second dimension. Thus, operating side clamps 106 and pivoting dead plate 108 compresses together, in first and second mutually orthogonal dimensions, a layer of items 18 prior to deposit on a surface therebelow. Thus, the process of building a layer row-by-row on lift head 22 results in some disorganization or loose fitting layers requiring, for optimal stacking, that the layers be compressed together in two dimensions, i.e. squeezed inward by bars 106 and plate 108, to make a compact organized layer ready for stacking on a surface therebelow.

In fact, a palletizer which permits significant disorganization in an item 18 layer while constructing such layer row-by-row promotes rapid construction of the layer. For example, certain layer building patterns require an interfitting relationship between rows within a layer. When such interfitting is required, it is easier and faster to initially form the layer as a loose organization of items 18 to better facilitate rows having items 18 interfitting with other rows.

Palletizer 10 facilitates such loose organization of a layer of items 18 during construction thereof at upward-facing side plates 109a and 109b. Generally, side plates 109 are upward facing, smooth surfaces adjacent the ends of rollers 100 on each side of layer head 22. Rollers 100 are of sufficient length to support a tightly-packed item 18 layer thereon. In accordance with the present invention, rollers 100 need not be any wider than necessary to support an item 18 layer thereon by virtue of support at side plates 109a and 109b. More particularly, a loosely fitting item 18 layer occupies more area, i.e., requires a greater support surface, than a tight-fitting item 18 layer. Side plates 109a and 109b support the outer edges of a loosely-fitting item 18 layer and thereby provide a greater area for supporting an item 18 layer during construction. In other words, layer head 22 tolerates significant disorganization among layers during layer formation and thereby facilitates rapid layer construction on layer head 22.

Once the layer has been loosely organized on the upward facing surfaces of layer head 22, i.e., on rollers 100 and side plates 109a and 109b, dead plate 108 and side clamps 106 operate to drive together and compress the loosely organized item 18 layer into a tightly fitting item 18 layer resting entirely on rollers 100.

As best seen in FIG. 4, the length of dead plate 108 corresponds to the length of rollers 100. Dead plate 108 includes, at each end, notches 108b and 108c, respectively. When plate 108 pivots upward, as indicated at reference numeral 108d in FIG. 5, notches 108b and 108c leave an open space therebelow to accommodate inward movement of clamps 106, i.e., inward and past the ends of dead plate 108. With dead plate 108 moved to its “clamping” position, i.e., pivoted inward to engage and compress and item 18 layer resting on layer head 22, side clamps 106 move inward and if necessary reach beyond the ends of rollers 100 to thereby compress together in coordination with dead plate 108 an entire item 18 layer from a loosely organized item 18 layer into a tightly-fitting item 18 layer. As may be appreciated stop 111 operates in coordination with clamps 106 and dead plate 108 to compress together an item 18 layer resting upon layer head 22. More particularly, stop 111 resists movement of an item 18 layer in response to dead plate 108 pivoting into its clamping position.

In FIG. 5, a pivot shaft 108g mounts rotatably to layer head 22 and carries thereon dead plate 108. A pair of pneumatic cylinders 108e couple by way of corresponding levers 108f to pivot shaft 108g. Thus, actuation of cylinders 108e causes movement of dead plate 108 between a transition position as shown in FIGS. 4 and 5 and a clamping position, i.e., pivoted inward as indicated at reference numeral 108g.

Thus, dead plate 108, rollers 100, side plates 109, stop 111 and side clamps 106 cooperatively tolerate significantly loose organization among items 18 when forming an item 18 layer and compress together items 18 in a tight fitting layer supported entirely on rollers 100.

Dead plate 108 provides a transition surface filling a gap between row conveyor 20 and layer head 22. Conventional dead plates, i.e., transition devices, are generally fixed in position. Dead plate 100 goes beyond a transition function and provides a compression function. The horizontal position of dead plate 108 provides, therefore, a transition surface function when item 18 rows are pushed onto layer head 22. After the last-to-arrive row of items 18 is located on layer head 22, dead plate 108 pivots up to compress and provide a secondary backstop for proper layer construction. Plate 108 thereby provides an ability to lower into a generally horizontal conventional dead plate position for a net fit between a reciprocating layer head 22 and whatever it mates with for receiving rows, e.g., a row conveyor 20. Pivoting dead plate 108 provides also a layer compression device which operates in opposition to stop 111 as provided across plates 110. In other words, dead plate 108 can push a layer against the stop 111 and thereby squeeze or compress the layer between plate 108 and stop 111.

Dead plate 108 provides a particularly important advantage during layer release, i.e., when rollers 100 are pulled from under an item 18 layer to drop the item 18 layer through layer head 22. As discussed above, dead plate 108 pivots into clamping or compressing engagement relative to an item 18 layer to better organize and make compact the item 18 layer in preparation for stacking. Leaving dead plate 108 in such engagement improves release of the first row of items dropped through layer head 22. More particularly, and especially with respect to smaller dimensioned items 18, dead plate 108 maintains a given and desired position for a row of items 18 when it remains in contact with the row of items 18 as they fall from of rollers 100 and onto a supporting surface therebelow. By guiding this first-to-drop row of items 18, dead plate 108 serves an additional guiding function relative to items 18 when releasing a row of items 18 from layer head 22. This first-to-drop row of items 18 then serves a similar guiding function relative to a next-to-drop row of items 18. Eventually, the last-to-drop row of items 18, i.e., those adjacent stop 111, fall through layer head 22 and find their final resting position on pallet 40 or on a stack of item 18 layers resting on pallet 40.

Prior art roller floors pulling support from under a layer of items suffer from a “loose” row which becomes more troublesome for narrower item 18 dimensions. In other words, the narrower item 18 is the greater its tendency to rock out of position when falling from rollers 100. In accordance with the present invention, however, dead plate 108 guides the first-to-drop item 18 row into position and begins a cascading series of supporting elements, i.e., each row is guided into position by the previous row and the first row is guided into position by dead plate 108. In this manner, an item 18 layer compressed together on layer head 22 achieves a more stable and better compressed final position after dropping through layer head 22 as it finds its final resting place on pallet 40 or on a stack of item 18 layers resting on pallet 40.

Compressive forces applied to an item 18 layer by virtue of the item 18 layer being captured and compressed between dead plate 108 and stop 111 also eliminate a dependence on conventional and undesirably variable compressive forces supplied by roller floors. In systems using only free rollers pulled from under an item 18 layer, the compressive force, i.e., against a fixed stop, varies as the roller bearings become more free turning by the unweighting thereof as items 18 fall therefrom. For particularly heavy items 18 and particularly free turning rollers 100, moving rollers 100 out of a supporting position does not generate significant compressive forces relative to a load, i.e., the load does not bear heavily against a fixed stop under such conditions. Under the present invention, however, dead plate 108 maintains static compression relative to an item 18 layer regardless of item 18 layer weight and degree of free-turning characteristic of rollers 100. As a result, an item 18 layer dropped through layer head 22 enjoys a more compact and better organized final resting place on pallet 40 or on a stack of item 18 layers resting on pallet 40.

Side plates 109 enhance use of rollers as a floor for a layer conveyor. The span occupied by rollers 100, i.e., as supported at each end thereof at chains 102, is limited by the strength and deflection characteristics of rollers 100. As may be appreciated, minimizing the length of rollers 100 to occupy just sufficient distance to support an entire item 18 layer minimizes the cost and structural requirements of rollers 100. Side plates 109 tolerate loose organization within an item 18 layer during construction thereof. In conventional practice, a forty inch wide finished width for a given item 18 layer requires a roller floor of over fifty inches wide to accommodate the layer during construction. Under the present invention, however, rollers 100 need only be forty inches wide because side plates 109 support the outer edges of a layer during construction thereof. As the roller floor, i.e., the support provided by rollers 100, width increases, the strength of the rollers must increase to avoid unacceptable deflection caused by the longer roller length. Increased strength requires increased weight and requires larger diameter rollers 100 as flooring for layer head 22. Both aspects negatively an inefficiently affect machine performance when roller length exceeds item 18 layer dimensions. In accordance with the present invention, however, rollers 100 are of minimal length just sufficient to support a tightly-organized item 18 layer thereon.

Thus, a synchronized palletizer has been shown and described. The synchronized palletizer of the present invention provides a compact overall size with high item throughput. Most low infeed, i.e., production level infeed, palletizers require a pallet position, a layer build position, and a row build conveyor. In accordance with the present invention, however, the layer build position is essentially eliminated by building layers row-by-row on the layer head 22 which also serves also as a layer placement mechanism, i.e., placing item 18 layers on a pallet 40 or stack of item 18 layers. This feature of the present invention is believed to save approximately 25% to 35% of otherwise required floor space. The synchronized palletizer of the present invention utilizes a relatively high speed row conveyor to chase down a current position of the layer head 22. Generally, conventional layer building brings each row to a fixed and maximum height, i.e., above any potential height for a stack of item 18 layers, for each and every row. In accordance with the present invention, however, each row need only be raised to the height of the current stack level, i.e., to where layer head 22 is positioned just above pallet 40 or a stack of item 18 layers resting on pallet 40. In this manner, the present invention reduces travel distance and travel time for rows conveyed to a layer building site.

While illustrated as having two side plates 109, one at each end of rollers 100, the present invention may be practiced with only one side plate 109. The important function being the presence of a support area beyond rollers 100 and adjacent thereto to facilitate loose packing of item 18 rows during construction of an item 18 layer on layer head 22.

It will be appreciated that the present invention is not restricted to the particular embodiment that has been described and illustrated, and that variations may be made therein without departing from the scope of the invention as found in the appended claims and equivalents thereof.

What is claimed is:

1. A palletizer comprising:
an infeed conveyor delivering serially items for palletizing;
a row conveyor receiving selected ones of said items as a row from said infeed conveyor; and
a layer head receiving selected ones of said items as a row from said row conveyor, said row conveyor and said layer head being reciprocated vertically and independently.

2. A palletizer according to claim 1 wherein said layer head occupies a space vertically above at least one of a pallet and a stack of layers on a pallet and discharges a layer of items through a floor thereof.

3. A palletizer according to claim 2 wherein said floor of said layer head comprises a set of free rollers spanning a pair of chains, said rollers being movable between a floor position and an open position, said open position allowing a layer to drop through a plane corresponding to said floor position.

4. A palletizer according to claim 3 wherein said layer head includes at least one upward facing support surface adjacent said rollers when said rollers are positioned in said floor position.

5. A palletizer according to claim 1 wherein said layer head includes a pivoting dead plate, said dead plate being movable between a generally horizontal position facilitating transfer of a row of items from said row conveyor and a clamping position engaging for compression a layer of said items on said layer head.

6. A palletizer according to claim 1 wherein said layer head includes a pair of side clamps movable inward and toward one another to engage for compression a layer of said items resting on said layer head.

7. A palletizer according to claim 1 wherein said layer head includes a layer conditioning mechanism compressing together a layer of items resting thereon in at least first and second dimensions.

8. A palletizer according to claim 7 wherein said first and second dimensions are mutually orthogonal dimensions.

9. A palletizer according to claim 1 wherein said layer head includes a pair of chains maintained in a generally L-shaped path and carrying thereacross and along corresponding segments thereof a set of free rollers, said rollers occupying a floor position when located along a horizontal portion of said L-shaped path and occupying an open position when located along a vertical portion of said L-shaped path.

10. A palletizer according to claim 1 wherein said layer head includes a set of free rollers movable between a floor position and an open position, said rollers having a length corresponding to a tightly-packed layer resting thereon when said rollers are in said floor position and dropping said layer through a plane containing said floor position when moved to said open position.

11. A palletizer according to claim 10 wherein said layer head comprises a pair of upward facing support surfaces at respective ends of said rollers when located at said floor position.

12. A method of palletizing comprising:
receiving serially items for palletization;
locating selected ones of said items row-by-row on a vertically reciprocating row conveyor;
moving said row conveyor to a height coincident with a layer head;
transferring laterally a row of said items from said row conveyor to said layer head while constructing a layer of rows on said layer head; and
dropping through a floor of said layer head a layer of said items onto at least one of a pallet and a stack of layers resting on said pallet therebelow.

13. A method according to claim 12 wherein said method further comprises conditioning by compressing a layer of said items as constructed on said layer head from a loosely packed layer into a tightly packed layer prior to dropping said layer through said layer head.

14. A method according to claim 12 wherein said step of dropping comprises moving from a supporting position below said layer a set of rollers to withdraw support thereof and allow said layer to drop vertically through said layer head.
